(19) United States
(12) Patent Application Publication
(10) Pub. No.: US 2013/0202499 A1
(43) Pub. Date: Aug. 8, 2013

(54) Composition and Sensor for Detecting Occult Blood

(71) Applicant: Kimberly-Clark Worldwide, Inc., Neenah, WI (US)

(72) Inventors: JunMo Gil, DaeJeon-Si (KR); Bao Trong Do, Decatur, GA (US); Teuta Elshani, Woodstock, GA (US); Todd Harmon Rogers, Lexington, KY (US)

(73) Assignee: Kimberly-Clark Worldwide, Inc., Neenah, WI (US)

(21) Appl. No.: 13/753,281

(22) Filed: Jan. 29, 2013

Related U.S. Application Data
(60) Provisional application No. 61/592,756, filed on Jan. 31, 2012.

(51) Int. Cl. G01N 21/78

(52) U.S. Cl. CPC G01N 21/78
USPC 422/425; 436/66

(57) ABSTRACT

An occult blood detection composition is used for various applications including that of predicting the start of menstruation. The composition may be applied to various devices to create a sensor, such devices include a feminine pad or shield, a badge, a swab or a wipe. The composition may be part of a kit wherein one component of the composition is applied to a device for the consumer. The remaining component of the composition, in liquid form, is applied to the device by the consumer prior to use.

This application claims priority as a continuation of Application No. 61/592,756, filed on filed on Jan. 31, 2012. The entirety of Application No. 61/592,756 is incorporated herein by reference.

### BACKGROUND

The disclosure relates to a composition for detecting occult blood and sensors for employing same. More specifically, the composition contains a specific leuco dye and sensors made therewith may be in the form of a disposable feminine care article, badge, swab or wipe.

Most women have a predictable menstrual cycle unless relatively young or in perimenopause. For one to two years after menarche, a young woman may have an irregular cycle that may range from 21 to 45 days. As she gets older and her body adapts to the hormonal changes of puberty, her menstrual cycle will become more regular and she will be able to predict when her period will start. Like young women, middle-age women approaching menopause may also experience irregular menstrual cycles. Some may cycle only a few times a year, and some may cycle more quickly than every 28 days. Regardless of age, one cannot easily predict the start of irregular menstrual cycles.

Trace blood undetectable with the naked eye (“occult blood”) is released in vaginal discharge about one to four days prior to the beginning of a menstrual cycle where visible blood is detected. There are technologies that have been developed for the detection of occult blood. One common composition used for detection of occult blood in forensic criminology is luminol. Other commercially available technologies for the detection of occult blood include CHEMISTRIP test strips (Roche Group), MULTISTIX reagent strips (Siemens) and EZ DETECT test kit (Biomerica Inc.). The latter three products detect occult blood through the oxidation of tetramethylbenzidine (TMB) or gum guaiac (GG) via the oxidation of the iron-center in hemoglobin by an organic peroxide.

While the referenced technologies are viable methods for detecting occult blood, they exhibit limitations. The luminol detection method uses chemiluminescence. Thus, occult blood detection requires multiple components so the use of luminol is relatively inconvenient. TMB has a safety profile that hinders its use as an occult blood detector intended to contact the vaginal area. Finally, while GG has a better safety profile than TMB, when occult blood is detected, the color change goes from pale yellow to blue. This does not fulfill the desire for a colorless-to-color reaction.

There remains a need for an occult blood detector that can reliably detect menstruation prior to onset. There also remains a need for an occult blood detector that can be incorporated in a device such as a wipe, swab, badge or feminine-care article. Further, there remains a need for a safe occult blood detector that initially is colorless, and develops a visually detectable color when in contact with occult blood.

### SUMMARY

In accordance with one embodiment of the present disclosure, a composition for detecting occult blood includes a benzoyl leuco methylene blue dye; a dye stabilizer; a color enhancer; and an oxidant. The composition of the present disclosure has several applications where detection of occult blood may be of tangible value. Such applications include feminine health, food processing, medical applications (e.g. colon, nasal and skin health), and forensic applications (criminology and toxicology).

In accordance with another embodiment of the present disclosure, a sensor for detecting occult blood includes an article having a surface onto which a composition is applied. The composition includes a benzoyl leuco methylene blue dye, a dye stabilizer, a color enhancer and an oxidant. The article may be a wipe, a swab or a feminine care article.

In accordance with yet another embodiment of the present disclosure, a sensor for detecting occult blood includes a substrate having a body-facing surface and an opposite garment facing surface. An occult-blood detecting composition is disposed on either the body-facing surface or the garment facing surface of the sensor. The occult-blood detecting composition may include a benzoyl leuco methylene blue dye, a dye stabilizer, a color enhancer and an oxidant. An fastener (e.g. an adhesive) is applied to the garment-facing surface of the substrate for the purpose of attaching the sensor to another surface such as underwear or the like.

In accordance with still a further embodiment of the present disclosure, a sensor kit is includes an article having a surface onto which a chromogen component of an occult-blood detecting composition is applied. The chromogen component may be a benzoyl leuco methylene blue dye. The article may be a wipe, a swab or a feminine care article such as a pad or tampon. A spray is included in the kit, the spray containing an oxidant.

Other features and aspects of the present disclosure are discussed in greater detail below.

### BRIEF DESCRIPTION OF DRAWINGS

A full an enabling disclosure, directed to one of ordinary skill in the art, is set forth more particularly in the remainder of the specification, which makes reference to the appended figures in which:

FIG. 1 is a plan view of one embodiment of a sensor in the form of a feminine pad;

FIG. 2 is a cross-sectional view of another embodiment of the present disclosure in the form of a badge;

FIG. 3 is a perspective view of yet another embodiment of the present disclosure in the form of a wipe;

FIGS. 4a-c and 5a-c and show the experimental results of different the occult-blood detection compositions according to the present disclosure;

FIG. 6 is a depiction of a reaction scheme showing the oxidation of hemoglobin, consequently, catalyzing the oxidation of BMLB;

FIG. 7 is one embodiment of a kit in accordance with the present disclosure.

Repeated use of reference characters in the present specification and drawings is intended to represent the same or analogous features or elements of the present disclosure. Not all analogous features are referenced by repeat reference characters. The drawings are representational and are not necessarily drawn to scale. Certain proportions thereof may be exaggerated, while others may be minimized.

Definitions

The term “adhesive” as used herein generally refers to a substance that bonds two faces of one or more substrates together.

The term “bond” refers to the adhering of two elements. Two elements will be considered to be bonded together when they are bonded directly or indirectly to one another.

The term “adhesive bonding” means a process which forms a bond by application of an adhesive. The application of adhesive composition may be by various processes such as slot coating, spray coating and other topical applications. Pressure may be applied to join the layers of a laminate.

The term “attached” as used herein means that there is direct contact between a layer X and a layer Y with no other material located between such layers unless specified, such as when an adhesive is used.

As used herein, the term “film” refers to a thermoplastic film made using a film extrusion and/or other forming process, such as a cast film or blown film extrusion process. The term includes apertured films, slit films, and other porous or microporous films which constitute liquid/vapor/air transfer films, as well as barrier films which do not transfer liquid.

Conventional “hot-melt adhesive” is an adhesive composition that generally comprises several components. A typical hot-melt adhesive composition might contain from about 15 to about 35 weight percent cohesive strength polymer or polymers; from about 50 to about 65 weight percent resin or other tackifier or tackifiers; from more than zero to about 30 weight percent plasticizer or other viscosity modifier; and optionally less than about 1 weight percent stabilizer or other additive. It should be understood that other adhesive compositions comprising different weight percentages of these components are possible.

As used herein the term “laminate” refers to a composite structure of two or more layers that have been joined to each other with an attachment or bonding step, such as through adhesive bonding, thermal bonding, point bonding, pressure bonding, extrusion coating or ultrasonic bonding.

“Liners” otherwise referred to as “topsheets” are commonly used in personal care articles such as diapers, feminine pads, incontinence garments and the like. Thus, the term topsheet describes a material that directly faces and makes contact with the skin.

The term “nonwoven” refers to a class of fabrics produced by attaching fibers (e.g. such as by chemical or mechanical means), or both. The nonwoven fabric is made by mechanical, chemical, thermal, or solvent means, or with an adhesive, or any combination of these, and is distinct from woven, knitted or tufted materials. Nonwoven fabrics may be made from synthetic thermoplastic polymers or natural polymers such as cellulose. For example, cellulosic tissue is one type of a nonwoven material.

“Particles” refer to any geometric form, such as, but not limited to, spherical grains, crystalline shapes, cylindrical fibers or strands, and the like. Particle sizes are defined infra.

“Meltblown” refers to a nonwoven web forming process that extrudes and draws molten polymer resins with heated, high velocity air to form fine filaments. The filaments are cooled and collected as a web onto a moving screen. The process is similar to the spunbond process, but meltblown fibers are much finer and generally measured in microns.

“Spunbond” refers to a nonwoven technology in which the filaments have been extruded, drawn and laid on a moving screen to form a web. The term “spunbond” is often interchanged with “spunlaid,” but the industry has conventionally adopted the spunbond or spunbonded term to denote a specific web forming process. This is to differentiate this web forming process from the other two forms of the spunlaid web forming, which are meltblown and flashspinning methods.

A spunbond/meltblown composite” is a laminar composite (laminate) that is generally made of various alternating layers of spunbond (“S”) and meltblown (“M”) webs: SMS, SMMS, SSMMS, etc.

As used herein, a “tissue product” generally refers to various paper products, such as facial tissue, bath tissue, paper towels, sanitary napkins, and the like. A tissue product of the present disclosure can generally be produced from a cellulosic web having one or multiple layers. For example, in one embodiment, the tissue product can be defined by a single-layered cellulosic web formed from a blend of fibers. In another embodiment, the tissue product can be defined by a multi-layered paper (i.e., stratified) web. Furthermore, the paper product can also be a single-or multi-ply product (e.g., more than one cellulosic web), wherein one or more of the plies may contain a cellulosic web formed according to the present disclosure. Normally, the basis weight of a tissue product of the present disclosure is less than about 120 grams per square meter (gsm), in some embodiments less than about 70 grams per square meter, and in some embodiments, between about 10 to about 40 gsm. One reference is U.S. Pat. No. 6,893,537 issued on May 17, 2005, is incorporated herein in a manner that is consistent therewith.

### DETAILED DESCRIPTION

The occult-blood detection (“OBD”) composition of the present disclosure may be used with various sensors forms. For example, the sensor form may be a panty shield or other feminine-care product capable of absorbing or otherwise capturing minimal amounts of vaginal discharge. Another form is a badge or strip that may be placed in a user's underwear adjacent the vaginal opening. Another form is a swab that may be used to sample vaginal fluid. Yet another form is a wipe that may be used to also sample vaginal fluid. Further, the OBD composition may be applied to an object or surface by a pump or aerosol spray, whereby the OBD composition may detect the presence of occult blood on any surface.

The OBD generally includes benzoyl leuco methylene blue (“BLMB”) dye, a dye stabilizer, a color enhancer and an oxidant. The OBD composition can detect when menstruation is going to occur within a range of about 36 hours prior to onset with presence of a detectable concentration of occult blood, and provides a visual signal by changing from a colorless state to a colored state where a bluish hue may be detected with an unaided eye. Occult-blood detection sensors are made by placing the OBD composition onto articles as described herein.

The OBD Composition

The main components of the OBD composition are: (i) a chromogen reagent in the form of BLMB (CAS 1249-97-4; C₂₃H₂₃N₃OS; and FW 389.51 g/mol, d 1.15 g/mL) dye to provide the color change, (ii) a chromogen stabilizer to prevent auto-oxidation of BLMB by oxygen (e.g. triethanolamine borate (CAS 283-56-7; C₆H₁₂BNO₃; FW 156.98 g/mol)), (iii) a color enhancer to increase color intensity (e.g. 6-methoxyquinoline (CAS 5263-87-6; C₁₀H₉NO; FW 159.19 g/mol)) and (iv) an oxidant to catalyze the color-change mechanism in the presence of hemoglobin (e.g. hydrogen peroxide—50 wt % in water (CAS 7722-84-1; H₂O₂; FW 34.02 g/mol; d 1.196 g/mL), or urea hydrogen peroxide (CAS 124-43-6; CH₄N₂O.H₂O₂; FW 94.07 g/mol)). The oxidant is not limited to a peroxide species; however, the oxidant exhibits redox properties of hydroxyl radicals. A reaction solution is prepared by combining the BLMB dye, chromogen stabilizer, and color enhancer prior to adding the oxidant thereto.

The chromogen reagent in the form of BLMB may be about 0.1 to about 20 percent by weight of the OBD composition, or about 0.1 to about 10 percent by weight, or about 3 percent by weight.

The chromogen stabilizer may be about 1 to about 25 percent by weight of the OBD composition, or about 1 to about 15 percent by weight, or about 5 percent by weight.

The color enhancer may be about 1 to about 30 percent by weight of the OBD composition, or about 1 to about 20 percent by weight, or about 15 percent by weight.

The oxidant may be about 5 to about 50 percent by weight of the OBD composition, or about 15 to about 40 percent by weight, or about 30 percent by weight.

Other reagents may be added to the composition as desired. To enable or ease the application of the OBD composition to a substrate, a surfactant (e.g. sodium dodecyl sulfate (CAS 151-21-3; C₁₂H₂₅NaO₄S; and FW 288.38 g/mol) and/or dimethyl sulfone (CAS 67-71-0; C₂H₆O₂S; and FW 94.13 g/mol) may be added to the OBD composition. The surfactant may be about 5 to about 40 percent by weight of the OBD composition.

To provide adequate sensor shelf-life, a preservative (e.g. citric acid (CAS 77-92-9; C₆H₈O₇; FW 192.12 g/mol), and/or sodium citrate (CAS 6132-04-3; Na₃C₆H₅O₇.2H₂O; FW 294.10 g/mol)) may be added to the OBD composition. The preservative may be about 5 to about 50 percent by weight of the OBD composition.

To prevent premature oxidation of the OBD composition, a metal scavenging component (e.g. ethylenediaminetetraacetic acid, disodium salt (EDTA); CAS 6381-92-6; C₁₀H₁₆N₂O₈; FW 372.24 g/mol)) may be added thereto. The metal scavenging component may be about 0.05 to about 5 percent by weight of the OBD composition.

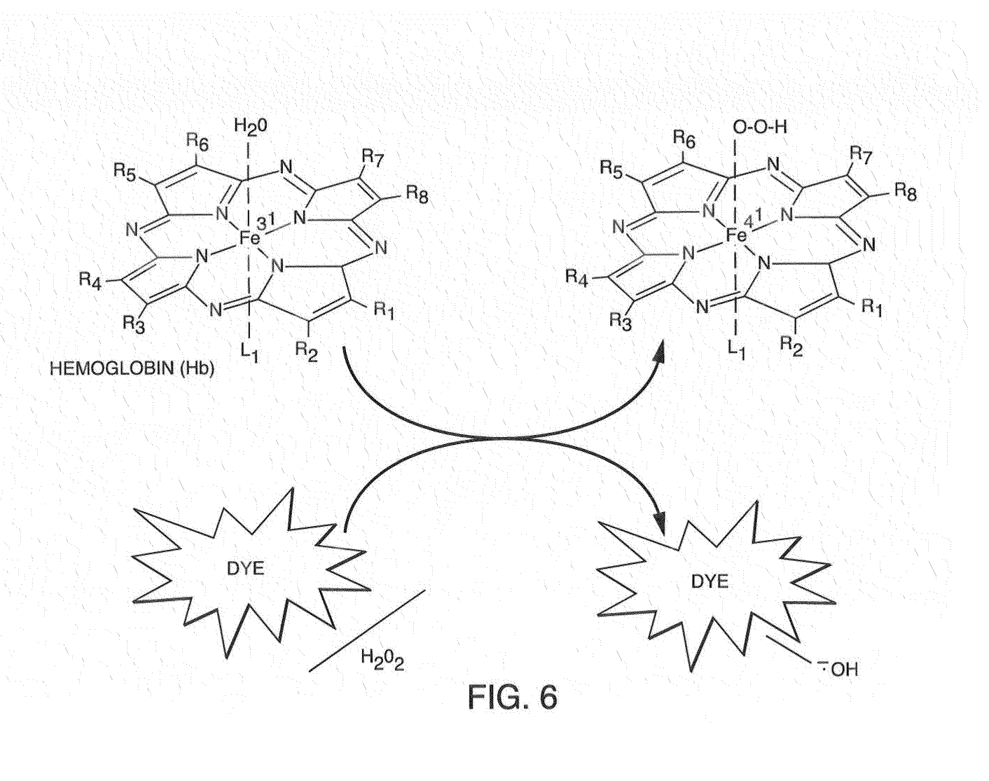

In operation, the sensor may be visually monitored without the use of optical devices. In the presence of trace amounts of blood, the occult-blood detection (“OBD”) composition irreversibly changes from a colorless appearance to a bluish color, often referred to as teal or blue-green. This color change is the product of oxidation of the BMLB dye by a hydroxyl radical. The hydroxyl radical forms by oxidating the hemoglobin iron-center of the blood with the oxidant component of the OBD composition. In the presence of visible blood, the BLMB composition changes appearance from colorless to blue. The mechanism triggering the color change is proposed in FIG. 6.

The OBD composition of the present disclosure provides certain advantages over the prior art. First, the utilization of hemoglobin in blood as a biomarker provides relatively high sensitivity due to its catalytic oxidative reaction. The catalytic oxidation of a chromogen needs only a trace (non-visible) amount of red blood cells. Second, while the referenced technologies are viable methods for detecting occult blood, they exhibit limitations. The luminol detection method uses chemiluminescence. Thus, occult blood detection requires multiple components so the use of luminol is relatively inconvenient. TMB has a safety profile that hinders its use as an occult blood detector intended to contact the vaginal area. Finally, while GG has a better safety profile than TMB, when occult blood is detected, the color change goes from pale yellow to blue. This does not fulfill the desire for a colorless-to-color reaction.

Sensors

Feminine Care Article.

The feminine care article of the present disclosure may be in the form of a sanitary napkin, panty shield, interlabial device or any other feminine care article designed for contact with vaginal exudates.

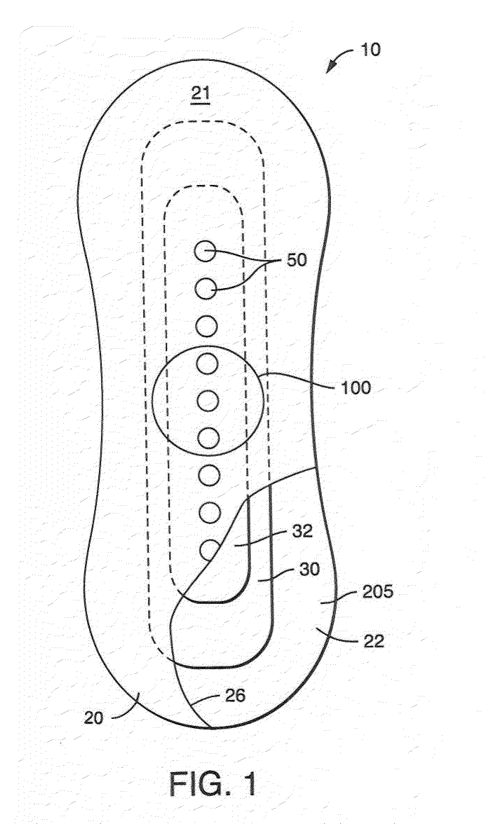

Referring to FIG. 1, one particular embodiment of a feminine care absorbent article 10 will now be described in more detail. More particularly, the article 10 includes a topsheet 20, a baffle 22, and an optional absorbent core 30 positioned between the topsheet 20 and the baffle 22. The topsheet 20 defines a body-facing surface 21 of the absorbent article 10. The absorbent core 30 is positioned inwardly from the outer periphery of the absorbent article 10 and includes a body-facing side positioned adjacent the topsheet 20 and a garment-facing surface positioned adjacent the baffle 22. Typically, the topsheet 20 and the baffle 22 are bonded by adhesive bonding, ultrasonic bonding, or any other suitable joining method known in the art, the sealed edges defining an overall sealed peripheral edge 40 of the article 10. The article 10 may take on various geometries but will generally have opposite lateral sides and longitudinal ends.

The topsheet 20 is generally designed to contact the body of the user and is liquid-permeable. The liquid permeable topsheet 20 has an outwardly facing surface that may contact the body of the user and receive aqueous fluids from the body. The topsheet 20 is provided for comfort and conformability and functions to direct bodily exudates away from the body, through the topsheet 20 and toward the absorbent core 30 or baffle 22. The topsheet 20 retains little or no liquid in its structure so that it provides a relatively comfortable and non-irritating surface next to the tissues within the vestibule of a female user.

The topsheet 20 may be constructed of any woven or nonwoven material that is easily penetrated by bodily exudates contacting the surface of the baffle. Examples of suitable materials include rayon, bonded carded webs of polyester, polypropylene, polyethylene, nylon, or other heat-bondable fibers, polyolefins, such as copolymers of polypropylene and polyethylene, linear low-density polyethylene, and aliphatic esters such as polylactic acid. Finely perforated film webs and net material can also be used. A specific example of a suitable topsheet material is a bonded carded web made of polypropylene and polyethylene such as that used as topsheet stock for KOTEX® pantiliners and obtainable from Sandler Corporation (Germany). U.S. Pat. No. 4,801,494 to Datta, et al. and U.S. Pat. No. 4,908,026 to Sukiennik, et al. teach various other topsheet materials that may be used in the present disclosure. The topsheet 20 may also contain a plurality of apertures (not shown) formed therethrough to permit body fluid to pass more readily into the absorbent core 30. The apertures may be randomly or uniformly arranged throughout the topsheet 20, or they may be located only in the narrow longitudinal band or strip arranged along the longitudinal axis of the absorbent article 10. The apertures permit rapid penetration of body fluid down into the absorbent core 30. The size, shape, diameter and number of apertures may be varied to suit one's particular needs.

The baffle 22 is generally liquid-impermeable and designed to face the inner surface, i.e., the crotch portion of an undergarment (not shown). The baffle 22 may permit a passage of air or vapor out of the absorbent article 10, while still blocking the passage of liquids. Any liquid-impermeable material may generally be utilized to form the baffle 22. For example, one suitable material that may be utilized is a microporous polymeric film, such as polyethylene or polypropylene. In particular embodiments, a polyethylene film is utilized that has a thickness in the range of about 0.2 mils to about 5.0 mils, and particularly between about 0.5 to about 3.0 mils. A specific example of a baffle material is a polyethylene film such as that used in KOTEX® pantiliners and obtainable from Pliant Corporation, Schaumburg, Ill., USA.

As indicated above, an absorbent core 30 may be positioned between the topsheet 20 and the baffle 22 that provides capacity to absorb and retain bodily exudates. The absorbent core 30 may be formed from a variety of different materials and contain any number of desired layers. For example, the core 30 typically includes one or more layers of an absorbent web material of cellulosic fibers (e.g., wood pulp fibers), other natural fibers, synthetic fibers, woven or nonwoven sheets, scrim netting or other stabilizing structures, superabsorbent material, binder materials, surfactants, selected hydrophobic and hydrophilic materials, pigments, lotions, odor control agents or the like, as well as combinations thereof.

In a particular aspect of the disclosure, the absorbent web material includes a matrix of cellulosic fluff, and may also include superabsorbent material. The cellulosic fluff may comprise a blend of wood pulp fluff. One preferred type of fluff, identified with the trade designation NB 416 and made available by Weyerhaeuser Corp., is a bleached and highly-absorbent wood pulp containing primarily soft wood fibers.

The absorbent materials may be formed into a web structure by employing various conventional methods and techniques. For example, the absorbent web may be formed with a dry-forming technique, an air forming technique, a wet-forming technique, a foam-forming technique, or the like, as well as combinations thereof. A coform nonwoven material may also be employed. Methods and apparatus for carrying out such techniques are well known in the art.

The topsheet 20 may be maintained in secured relation with the absorbent core 30 by bonding all or a portion of the adjacent surfaces to one another. A variety of bonding mechanisms known to one of skill in the art may be utilized to achieve any such secured relation. Examples of such mechanisms include, but are not limited to, the application of adhesives in a variety of patterns between the two adjoining surfaces, entangling at least portions of the adjacent surface of the absorbent with portions of the adjacent surface of the cover, or fusing at least portions of the adjacent surface of the cover to portions of the adjacent surface of the absorbent. The topsheet 20 typically extends over the upper, bodyside surface of the absorbent core 30, but can alternatively extend around the article to partially or entirely, surround or enclose the absorbent core. Alternatively, the topsheet 20 and the baffle 22 can have peripheral margins that extend outwardly beyond the terminal, peripheral edges of the absorbent core 30, and the extending margins may be joined together to partially or entirely, surround or enclose the absorbent core.

Although not required, the absorbent article 10 may also contain other additional layers as is known in the art. In FIG. 1, for example, a liquid-permeable intake layer 32 is positioned vertically between the topsheet 20 and the absorbent core 30. The intake layer 32 may be made of a material that is capable of rapidly transferring, in the z-direction, body fluid that is delivered to the topsheet 20. The intake layer 32 may generally have any shape and/or size desired. In one embodiment, the intake layer 32 has a rectangular shape, with a length equal to or less than the overall length of the absorbent article 10, and a width less than the width of the absorbent article 10. For example, a length of between about 150 mm to about 300 mm and a width of between about 10 mm to about 60 mm may be utilized. Any of a variety of different materials may be used for the intake layer 32 to accomplish the above-mentioned functions. The material may be synthetic, cellulosic, or a combination of synthetic and cellulosic materials. For example, airlaid cellulosic tissues may be suitable for use in the intake layer 32. The airlaid cellulosic tissue may have a basis weight ranging from about 10 grams per square meter (gsm) to about 300 gsm, and in some embodiments, between about 40 gsm to about 150 gsm. The airlaid tissue may be formed from hardwood and/or softwood fibers. The airlaid tissue has a fine pore structure and provides an excellent wicking capacity, especially for menses.

The absorbent article 10 may also contain a transfer delay layer (not shown) positioned between the intake layer 32 and the absorbent core 30. The transfer delay layer handles surges of fluid and may contain a material that is substantially hydrophobic, such as a nonwoven web composed of polypropylene, polyethylene, polyester, etc. One example of a material suitable for the transfer delay layer is a spunbond web composed of polypropylene, multi-lobal fibers. Further examples of suitable transfer delay layer materials include spunbond webs composed of polypropylene fibers, which may be round, tri-lobal or poly-lobal in cross-sectional shape and which may be hollow or solid in structure. Typically the webs are bonded, such as by thermal bonding, over about 3% to about 30% of the web area. Other examples of suitable materials that may be used for the transfer delay layer 36 are described in U.S. Pat. No. 4,798,603 to Meyer, et al. and U.S. Pat. No. 5,248,309 to Serbiak, et al. To adjust performance, the transfer delay layer may also be treated with a selected amount of surfactant to increase its initial wettability. The transfer delay layer typically has a basis weight less than that of the other absorbent members. For example, the basis weight of the transfer delay layer 36 is typically less than about 250 grams per square meter (gsm), and in some embodiments, between about 40 gsm to about 200 gsm.

The absorbent article 10 may also include laterally extending wing portions (not shown) that may be integrally connected to side regions along the intermediate portion of the article. For example, the wing portions may be separately provided members that are subsequently attached or otherwise operatively joined to the intermediate portion of the article.

The OBD composition 50 is typically applied to a layer of the article where it can be easily seen by the user. In the embodiment shown in FIG. 1, for example, the OBD composition 50 may be applied to the body-facing surface 21 of topsheet 20 (e.g., uniformly or non-uniformly). In certain aspects of the present disclosure, however, the OBD composition is located on either the garment-facing surface of topsheet 20 or on another layer of the absorbent article 10 (e.g., intake layer, transfer delay layer, etc.) that is in close proximity to the user's body. If desired, a transparent or translucent window 100 in liner 20 may be employed to allow the OBD composition 50 to be readily viewed without removal of the absorbent article from the user and/or without disassembly. Window 100 may be made from a flexible translucent or transparent film that can be attached to the topsheet material. In other embodiments, the OBD composition 50 can be seen through an aperture (not shown) in topsheet 20 for visual inspection.

In other aspects of the disclosure, topsheet 20 may be without commonly used opaque fillers or the like so that the topsheet 20 material (film or nonwoven) has a relatively high degree of light transmission. Such a topsheet 20 would be particularly beneficial in the context of sensors that are located inside the article. To allow visual inspection of the article 10 components, the topsheet 20 can be transparent or can be only partially transparent. It is, however, sufficient for most embodiments according to the present disclosure if the topsheet 20 is translucent to allow visual inspection of a color change.

Badge

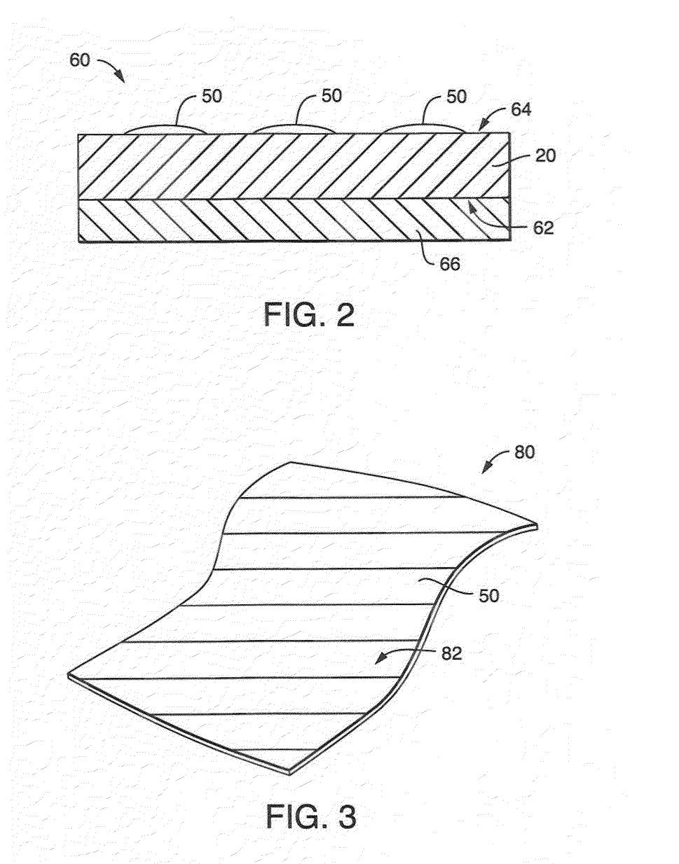

Referring now to FIG. 2, the sensor may be in the form of a badge shown as article 60. Article 60 is defined by a substrate such as the liner material 20 described above. An attachment means for temporarily attaching article 60 to a garment is applied to the garment-facing side 62 of article 60. In one aspect, a layer of adhesive 66 is applied to surface 62.

Like article 10, the OBD composition 50 may be applied to either the garment-facing surface 62 or the opposite body-facing surface 64. The composition may form a pattern such as stripes, dots, or an identifiable or random shape, or may be applied to continuously cover the desired surface.

The size and shape of article 60 may vary widely. The shape of article 60 may be a geometric shape (e.g. rectangle, oval or circle), an amorphous shape, or a recognizable shape (e.g. a single flower or elongated string of flowers). Any shape and size will work as long as article 60 can be disposed on a garment so that is in contact with vaginal exudates.

Swab

In another aspect of the present disclosure, an effective amount of the OBD composition may be disposed onto the fibrous end of a swab (not shown). The form of the swab may be similar to that sold under the Q-TIP brand, sold by Johnson & Johnson, or any generic swab whether tipped with natural materials (e.g. cotton) or synthetic materials. In operation, the user contacts the swab with the vaginal exudates located on a garment or the body, and visually inspects the fibrous end of the swab for a color change.

Wipe

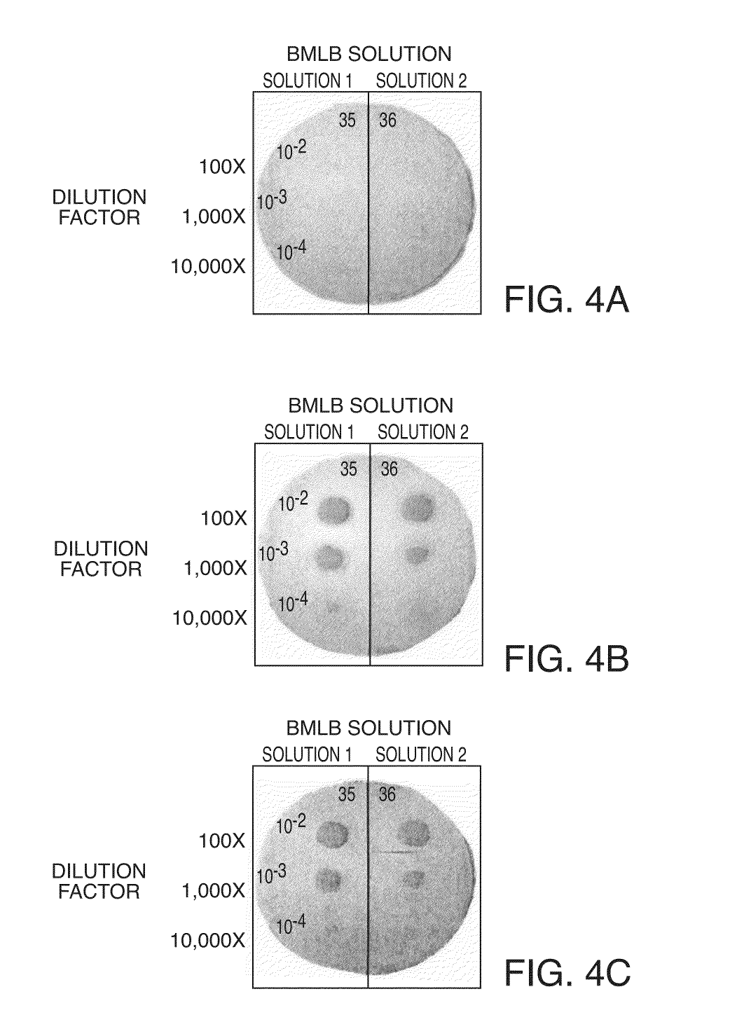

In yet another aspect of the disclosure, an effective amount of the OBD composition 50 is applied to a surface 82 of a wipe designated as article 80 in FIG. 3. In general, any suitable fibrous web may be used to make wipes in accordance with the present disclosure. For example, in one embodiment, the wipe can be a tissue product, such as a bath tissue, a facial tissue, a paper towel and the like. The tissue products may contain one or more plies.

In one aspect of the present disclosure, fibers suitable for making a wipe material are natural or synthetic cellulosic fibers including, but not limited to, nonwoody fibers, such as cotton, abaca, kenaf, sabai grass, flax, esparto grass, ramie, straw, jute hemp, bagasse, milkweed floss fibers, and pineapple leaf fibers; and woody or pulp fibers such as those obtained from deciduous and coniferous trees, including softwood fibers, such as northern and southern softwood kraft fibers; hardwood fibers, such as eucalyptus, maple, birch, and aspen. Pulp fibers can be prepared in high-yield or low-yield forms and can be pulped in any known method, including kraft, sulfite, high-yield pulping methods and other known pulping methods. Fibers prepared from organosolv pulping methods can also be used, including the fibers and methods disclosed in U.S. Pat. No. 4,793,898, issued to Laamanen et al.; U.S. Pat. No. 4,594,130, issued to Chang et al.; and U.S. Pat. No. 3,585,104. Useful fibers can also be produced by anthraquinone pulping, exemplified by U.S. Pat. No. 5,595,628 issued to Gordon et al.

Desirably, the wipe material has a white color so that the OBD composition color change is seen readily. Any known bleaching method may be used. Chemically treated natural cellulosic fibers may also be used such as mercerized pulps, chemically stiffened or crosslinked fibers, or sulfonated fibers. To maintain the best mechanical properties of the papermaking fibers, it is desirable that the fibers be relatively undamaged, largely unrefined or only lightly refined. While recycled fibers can be used, virgin fibers are generally useful for their optimal mechanical properties and lack of contaminants. Mercerized fibers, regenerated cellulosic fibers, cellulose produced by microbes, rayon, and other cellulosic material or cellulosic derivatives can be used. Suitable papermaking fibers can also include recycled fibers, virgin fibers, or mixes thereof. In certain, to have high bulk and good compressive properties, the fibers may have a Canadian Standard Freeness of at least 200, more specifically at least 300, more specifically still at least 400, and most specifically at least 500.

Other papermaking fibers that can be used in the present disclosure include paper broke or recycled fibers and high yield fibers. High yield pulp fibers are those papermaking fibers produced by pulping processes providing a yield of about 65% or greater, more specifically about 75% or greater, and still more specifically about 75% to about 95%. The term “yield” as used herein is the resulting amount of processed fibers expressed as a percentage of the initial wood mass. Such pulping processes include bleached chemithermomechanical pulp (BCTMP), chemithermomechanical pulp (CTMP), pressure/pressure thermomechanical pulp (PTMP), thermomechanical pulp (TMP), thermomechanical chemical pulp (TMCP), high yield sulfite pulps, and high yield Kraft pulps, all of which leave the resulting fibers with high levels of lignin. High yield fibers are well known for their stiffness in both dry and wet states relative to typical chemically pulped fibers.

In other aspects of the present disclosure, the wipe is made from a meltblown or spunbond web, or a combination thereof.

Desirably, the OBD composition 50 is printed onto one or both surfaces of the wipe referred to as article 80. The OBD composition may be applied in a variety of patterns, either recognizable shapes, geometric patterns or random patterns. The composition 50 may continuously or non-continuously cover the wipe surface area on at least one side thereof.

The OBD composition 50 may further be applied to the article 80 by spraying or dipping the web or wipe during manufacture.

Spray or Drops

Not only can spraying occur during manufacture, consumers may apply the composition with a spray device (e.g. aerosol or pump) or a dropper so that the composition may be applied to any surface. This will allow one to prepare wipe-like items from bathroom tissue or the like, or directly apply the composition of the present disclosure to a used feminine article such as a pad. In addition, it enables the composition to be used in other applications (e.g. forensic or medical) such as detecting occult blood in hard to reach places or areas that are not to be disturbed with a wipe or swab.

Kit

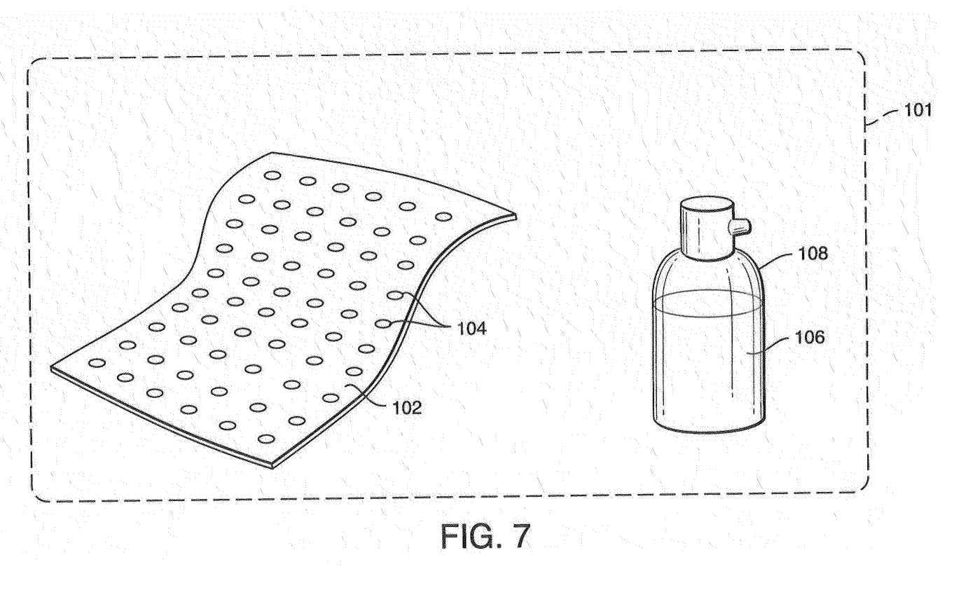

In another aspect, a device such as wipe, swab, badge or feminine article may be provided to the consumer as part of a kit 101, an example of which is shown in FIG. 7. In this example, a device such as wipe 102 onto which the chromogen component 104 of the composition (see Example 1) has been pre-applied is provided to the consumer in dry form. The oxidant component 106 of the composition (see Example 1) is provided liquid form to the consumer, such as in a spray bottle 108. The oxidant component is sprayed onto the device by the consumer just before use. One advantage of this approach is a longer shelf life of the product.

In another example, pretreated wipes or swabs as described above may be sold together with feminine products such as pantiliners. Instructions as to how to use the kit of either example may be included.

### EXAMPLES

### Example 1

Preparation of “chromogen component”: Benzoyl leuco methylene blue dye (0.4 mg; 1.0×10⁻⁶ mol) was dissolved in an isopropyl alcohol (0.8 mL)/acetone (0.2 mL) mixture to form a solution. Triethanolamine borate (6 mg; 3.8×10⁻⁵ mol) was dissolved in water (0.2 mL) and added to the solution. 6-methoxyquinoline (16 mL; 18.4 mg; 1.2×10⁻⁴ mol) was subsequently added to the solution.

Preparation of “oxidant component”: Hydrogen peroxide—50 wt % in water (80 mL; 47.8 mg H₂O₂, 1.4×10⁻³ mol) was dissolved in water (0.92 mL).

Solution 1: To prepare Solution 1, the oxidant component was mixed with the chromogen component.

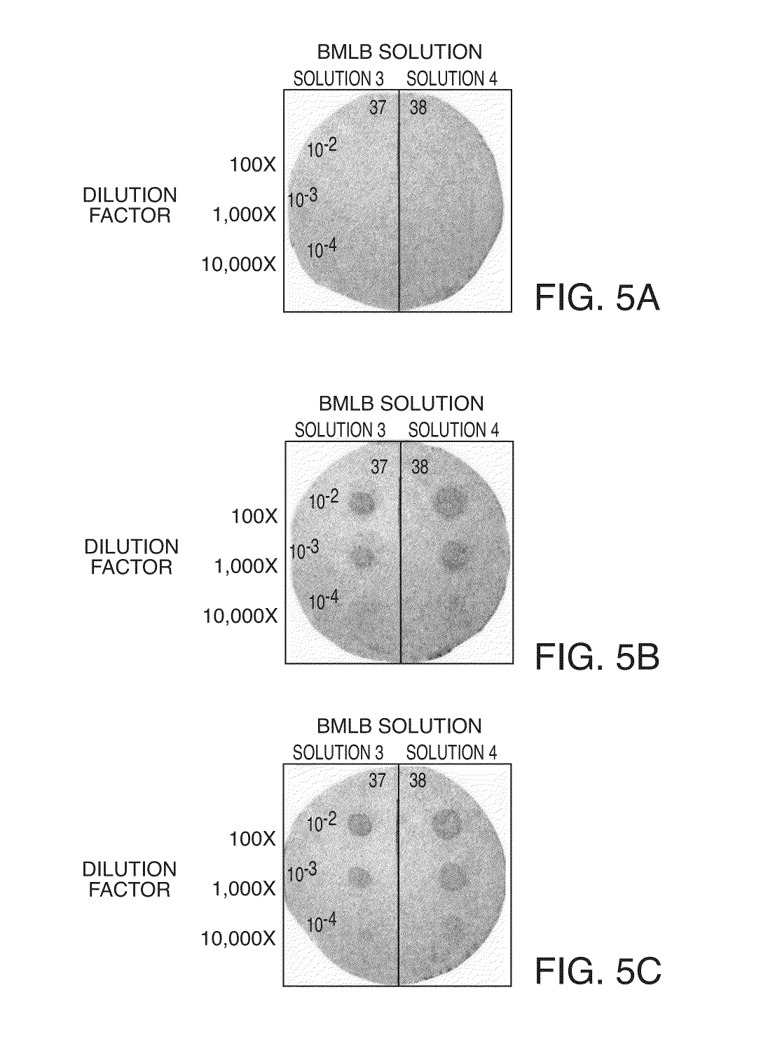

Referring to FIGS. 4(a)-(c), three 15 μL samples of the resulting Solution 1 were deposited at discrete areas onto region 35 of a filter paper and allowed to dry for approximately ten minutes.

Three 15 μL samples of swine blood, defibrinated, (available from Cocalico Biologicals, Inc., Reamstown, Pa.) in vaginal fluid simulant (prepared as indicated in journal article: Contraception, Volume 59, Issue 2, Pages 91-95, February 1999; Derek H. Owen, David F. Katz) was deposited onto each of the Solution 1 samples at three different levels of dilution (100×, 1000×, and 10000× dilution factors). Within 2 minutes, a bluish color appeared at the area of deposition (see FIG. 4b). This color was still present 1.5 hours after deposition (see FIG. 4c).

### Example 2

Preparation of “chromogen component”: The chromogen component is described in Example 1.

Preparation of “oxidant component”: Urea hydrogen peroxide (0.05 g, 5.3×10⁻⁴ mol) was dissolved in water (1 mL).

Solution 2: To prepare Solution 2, the oxidant component was mixed with the chromogen component.

Referring to FIGS. 4(a)-(c), three 15 μL samples of the resulting Solution 2 were deposited at discrete areas onto region 36 of a filter paper and allowed to dry for approximately ten minutes.

Three 15 μL samples of the swine blood in vaginal fluid simulant (supra) was deposited onto each of the Solution 2 samples at three different levels of dilution (100×, 1000×, and 10000× dilution factors). Within 2 minutes, a bluish color appeared at the area of deposition (see FIG. 4b). This color was still present 1.5 hours after deposition (see FIG. 4c).

### Example 3

Preparation of “chromogen component”: The chromogen component is described in Example 1.

Preparation of “oxidant component”: Citric acid (25 mg; 1.3×10⁻⁴ mol), sodium citrate (20 mg; 6.8×10⁻⁵ mol), EDTA (1 mg; 2.7×10⁻⁶ mol), SDS (9 mg; 3.1×10⁻⁵ mol), and dimethyl sulfone (22 mg; 2.3×10⁻⁴ mol) were dissolved in water (0.92 mL) to form a solution. Hydrogen peroxide—50 wt % in water (80 mL; 47.8 mg H₂O₂, 1.4×10⁻³ mol) was added to the solution and mixed.

Solution 3: To prepare Solution 3, the oxidant component was mixed with the chromogen component. As a result, Solution 3 includes reagents for printing purposes as described above: surfactants (sodium dodecyl sulfate and dimethyl sulfone), preservatives (citric acid and sodium citrate) and metal scavenging components (EDTA).

Referring to FIGS. 5(a)-(c), three 15 μL samples of the resulting Solution 3 were deposited at discrete areas onto region 37 of a filter paper and allowed to dry for approximately ten minutes.

Three 15 μL samples of the swine blood in vaginal fluid simulant (supra) was deposited onto each of the Solution 3 samples at three different levels of dilution (100×, 1000×, and 10000× dilution factors). Within 1 minute, a bluish color appeared at the area of deposition (see FIG. 5b). This color was still present 1.5 hours after deposition (see FIG. 5c).

### Example 4

Preparation of “chromogen component”: The chromogen component is described in Example 1.

Preparation of “oxidant component”: Citric acid (25 mg; 1.3×10⁻⁴ mol), sodium citrate (20 mg; 6.8×10⁻⁵ mol), for ethylenediaminetetraacetic acid (1 mg; 2.7×10⁻⁶ mol), SDS (9 mg; 3.1×10⁻⁵ mol), dimethyl sulfone (22 mg; 2.3×10⁻⁴ mol), and urea hydrogen peroxide (0.05 g, 5.3×10⁻⁴ mol) were dissolved in water (1 mL) to form a solution.

Solution 4: To prepare Solution 4, the oxidant component was mixed with the chromogen component. As a result, Solution 4 includes reagents for printing purposes as described above: surfactants (sodium dodecyl sulfate and dimethyl sulfone), preservatives (citric acid and sodium citrate) and metal scavenging components (ethylenediaminetetraacetic).

Referring to FIGS. 5(a)-(c), three 15 μL samples of the resulting Solution 4 were deposited at discrete areas onto region 38 of a filter paper and allowed to dry for approximately ten minutes.

Three 15 μL samples of the swine blood in vaginal fluid simulant (supra) was deposited onto each of the Solution 4 samples at three different levels of dilution (100×, 1000×, and 10000× dilution factors). Within 1 minute, a bluish color appeared at the area of deposition (see FIG. 5b). This color was still present 1.5 hours after deposition (see FIG. 5c).

### Example 5

Occult Blood Detection Composition—Clinical Sample

A clinical study was executed to demonstrate the occult blood detection composition was viable against real menses samples. The occult blood detection composition was the BLMB composition of Example 1. The subjects comprised women ages 12 to 22. The study demonstrated that the composition is successful in detecting the presence of occult blood (hemoglobin) of unfiltered menses.

Twelve young women (15-22 yrs old) and twelve girls (12-14 yrs old) were given enough KOTEX® LIGHTDAYS liners for two menstrual cycles. The collection of used liners and distribution of new liners took place on a weekly basis. Used liners were processed the same or following week. “Processing” entailed spraying the used liners with the BLMB formulation and visually assessing any color change.

The total number of used liners collected and processed was 1020. The percentage of liners showing the presence of occult blood in this study was 37.5%.

1. A composition for detecting occult blood comprising:
a benzoyl leuco methylene blue dye;
a dye stabilizer;
a color enhancer; and
an oxidant.

2. The composition of claim 1 comprising 0.1 to 20% benzoyl leuco methylene blue dye.

3. The composition of claim 1 comprising 3% benzoyl leuco methylene blue dye.

4. The composition of claim 1 wherein the chromogen stabilizer comprises triethanolamine borate.

5. The composition of claim 4 comprising 1 to 15% triethanolamine borate.

6. The composition of claim 1 wherein the color enhancer comprises 6-methoxyquinoline.

7. The composition of claim 6 wherein comprising 1 to 20% 6-methoxyquinoline.

8. The composition of claim 1 further comprising a surfactant selected from the group consisting of sodium dodecyl sulfate, dimethyl; sulfone and combinations thereof.

9. The composition of claim 1 further comprising 5 to 40% surfactant.

10. The composition of claim 1 further comprising a preservative selected from the group consisting of citric acid, sodium citrate and combinations thereof.

11. The composition of claim 1 further comprising a ethylenediaminetetraacetic acid, disodium salt.

12. A sensor for detecting occult blood comprising an article having a surface onto which the composition of claim 1 is applied, the article selected from the group consisting of a wipe, a badge, a swab and a feminine care article.

13. A sensor for detecting occult blood comprising:
a substrate having a body-facing surface and an opposite garment facing surface;
wherein an occult-blood detecting composition is disposed on either the body-facing surface or the garment facing surface, the occult-blood detecting composition comprising benzoyl leuco methylene blue dye, a chromogen stabilizer, a color enhancer and an oxidant; and
an fastener attached to the garment-facing surface of the substrate, wherein the fastener is configured to attach the substrate to a surface.

14. The sensor of claim 13 wherein the color enhancer comprises 6-methoxyquinoline, the chromogen stabilizer comprises triethanolamine borate, and the oxidant comprises a peroxide.

15. A sensor kit for the detection of occult blood comprising:
an article having a surface onto which a chromogen component of an occult-blood detecting composition is applied, the article selected from the group consisting of a wipe, a swab and a feminine care article; and
a spray comprising an oxidant;
wherein the chromogen component comprises a benzoyl leuco methylene blue dye.
